(19) United States
(12) Patent Application Publication
(10) Pub. No.: US 2010/0234525 A1
(43) Pub. Date: Sep. 16, 2010

(54) Method and Composition for Making Floor Tiles Dust Resistant

(75) Inventor: Tareq Abduljalil Albahri, (US)

Correspondence Address: LITMAN LAW OFFICES, LTD., POST OFFICE BOX 41200, SOUTH STATION, ARLINGTON, VA, 22204, US

(73) Assignee: University of Kuwait

(21) Appl. No.: 12/403,378

(22) Filed: Mar. 12, 2009

(51) Int. Cl. C08F 214/04; C08L 9/00; C08L 9/06; C08L 7/00; C08L 23/18

(52) U.S. Cl. 524/567; 524/574; 524/575; 524/575.5; 524/579

(57) ABSTRACT

There is disclosed a method and compounds for treating floor tiles to make them dust proof. Treated tiles by said method and compounds acquire the property of not collecting dust after dust storms in dusty regions and having a clean appearance. The disclosed method comprises coating of said tiles with said chemical compounds by rubbing to create a thin transparent protective sealing layer which prevents the sticking of dust particles that are eventually swept away by winds. The disclosed method is simple and the disclosed compounds are widely available and cheap. Furthermore, the invention saves money and effort of continuously cleaning in dusty regions.

### FIELD OF THE INVENTION

The present invention relates generally to making flooring dust resistant.

### BACKGROUND OF THE INVENTION

Flooring tiles collect dust after dust storms in dusty regions and do not have a clean appearance.

1. Prior Art Reference and Discussion

No prior art describes using rubber for treating or coating tiles to make them dust resistant or dustless. No prior art was found using the following keywords (rubber, dust, tiles) or (rubber, dustless, tiles) together.

Japanese Patent no. 63-286471 (1988) to Takami et al. discloses a composition suitable for homogeneous tiles of vinyl chloride type or for dry care system, having excellent adhesivity, durability, dust resistance and proper gloss, by copolymerizing an amide monomer with an ethylene unsaturated carboxylic acid in a specific ratio. The invention is related to the making of synthetic vinyl tiles, not the dust proofing of ceramic, granite, marble, or cement type synthetic tiles.

2. Difference with Prior Art

Japanese Patent no. 63-286471 (1988) to Takami et al. relates to the making of synthetic vinyl tiles that have dust resisting properties. The present invention provides dust proofing of ceramic, granite, marble, or laminated cement type synthetic tiles that have been installed or not yet installed.

### SUMMARY OF THE INVENTION

The object of invention is to make floor tiles dust resistant in a sense that they do not collect dust in dusty regions and look clean.

The solution is that floor tiles are coated with chemical compounds which provide a thin transparent protective sealing layer that prevents the sticking of dust particles that are eventually swept away by winds. Treated tiles by said method and compounds acquire the property of not collecting dust after dust storms in dusty regions and having a clean appearance. The disclosed method comprises coating of said tiles with said chemical compounds by rubbing to create a thin transparent protective sealing layer which prevents the sticking of dust particles that are eventually swept away by winds. The disclosed method is simple and the disclosed compounds are widely available and cheap. Furthermore, the invention saves money and effort of continuously cleaning in dusty regions.

### BRIEF DESCRIPTION OF THE DRAWINGS

The above and other aspects, features, methods, processes and advantages of the present invention will be better and more fully understood by those skilled in the art with reference to the following detailed and more particular description of specific and preferred embodiments thereof, presented in conjunction with the following drawings to show how the same may be carried into effect, wherein:

FIG. 1 is a view of the tile before treatment;

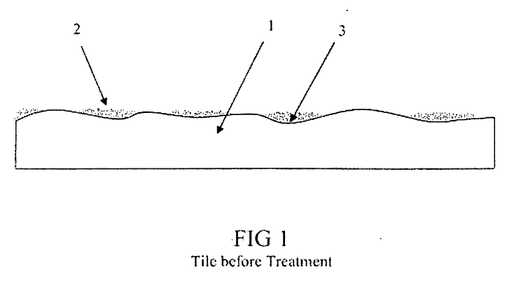

FIG. 2 is a view of the tile after treatment;

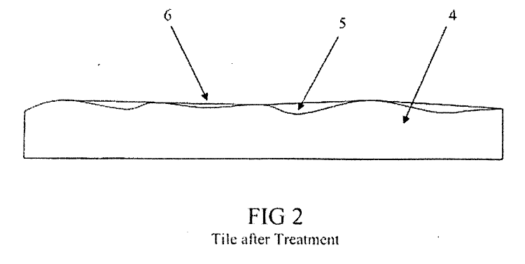

FIG. 3a is a representative side view of an assembly-line-like coating treatment of the new floor tiles using the first method;

FIG. 3b is a representative an angle view of an assembly-line-like coating treatment of new floor tiles using the first method; and

FIG. 4 is a view of coating treatment of pre-installed floor tiles using the second method.

### DETAILED DESCRIPTION OF BEST MODE FOR CARRYING OUT THE INVENTION

There will now be described, by way of example only, the best mode contemplated by the inventor for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

The inventor discovered that when tiles are treated with rubber or polymer they acquire dust resistant properties and that such treatment can make tiles dust resistant.

Natural rubber coming from latex is mostly polymerized isoprene with a small percentage of impurities in it. There are limitations on the proportions of cis and trans double bonds resulting from methods of polymerizing natural latex which limits the range of properties available to natural rubber, although addition of sulfur and vulcanization are used to improve the properties. Vulcanization, or curing of rubber, is a chemical process in which individual polymer molecules, to a greater or lesser extent, are cross-linked to other polymer molecules by atomic bridges. This makes the bulk material harder, much more durable and also more resistant to chemical attack. It also makes the surface of the material smoother and prevents it from sticking to metal or plastic chemical catalysts. This heavily cross-linked polymer has strong covalent bonds, with strong forces between the chains, and is therefore an insoluble and infusible, thermosetting polymer or thermoset.

Isoprene is a common synonym for the chemical compound 2-methylbuta-1,3-diene. It is commonly used in industry, is an important biological material, and can be a harmful environmental pollutant and toxicant when present in excess quantities. It is most readily available industrially as a by-product of the thermal cracking of naphtha or oil. About 95% of isoprene production is used to produce cis-1,4-polyisoprene—a synthetic version of natural rubber.

Natural rubber is a polymer of isoprene—most often cis-1,4-polyisoprene—with a molecular weight of 100,000 to 1,000,000. Typically, a few percent of other materials, such as proteins, fatty acids, resins and inorganic materials are found in high quality natural rubber. Some natural rubber sources called gutta percha are composed of trans-1,4-polyisoprene, a structural isomer which has similar, but not identical properties.

Today most tires, especially those fitted to motor vehicles, are manufactured from synthetic rubber. An urgent need for synthetic rubber that is derived from widely distributed feedstocks grew out of the expanded use of motor vehicle tires starting in the 1890s. Political problems that resulted from great fluctuations in the cost of natural rubber in 1921 led to supported rubber prices by regulating production. By 1925 the price of natural rubber had increased to the point that companies such a DuPont were exploring methods of producing synthetic rubber to compete with natural rubber. In the case of DuPont the effort lead to the discovery of Neoprene which is a synthetic rubber that is too expensive to be used in tires, but has some very desirable properties that make it possible to use rubber in applications that would be unsuitable for natural rubber. Neoprene is the DuPont Performance Elastomers trade name for a family of synthetic rubbers based on polychloroprene (polymer form of Chloroprene). DuPont focused on monovinyl acetylene and reacted the substance with hydrogen chloride gas, manufacturing chloroprene. Polychloroprene is the polymer of chloroprene, the synthetic rubber known as Neoprene.

Synthetic rubber is any type of artificially made polymer material which acts as an elastomer. An elastomer is a material with the mechanical (or material) property that it can undergo much more elastic deformation under stress than most materials and still return to its previous size without permanent deformation. Synthetic rubber serves as a substitute for natural rubber in many cases, especially when improved material properties are needed.

Synthetic rubber can be made from the polymerization of a variety of monomers including isoprene (2-methyl-1,3-butadiene), 1,3-butadiene, chloroprene (2-chloro-1,3-butadiene), and isobutylene (methylpropene) with a small percentage of isoprene for cross-linking. Furthermore, these and other monomers can be mixed in various desirable proportions to be copolymerized for a wide range of physical, mechanical, and chemical properties. The monomers can be produced pure and addition of impurities or additives can be controlled by design to give optimal properties. Polymerization of pure monomers can be better controlled to give a desired proportion of cis and trans double bonds.

Butyl rubber, also known as polyisobutylene (C4H8), is a synthetic rubber, a homopolymer of 2-methyl-1-propene. Polyisobutylene is produced by polymerization of about 98% of isobutylene with about 2% of isoprene. Structurally, polyisobutylene resembles polypropylene, having two methyl groups substituted on every other carbon atom. It has excellent impermeability, and the long polyisobutylene segments of its polymer chains give it good flex properties. Polyisobutylene is a colorless to light yellow elastic semi-solid or viscous substance. It is generally odorless and tasteless, though it may exhibit a slight characteristic odor.

A synthetic rubber, or elastomer, polyisobutylene is impermeable to air and used in many applications requiring an airtight rubber. The first major application of butyl rubber was tire inner tubes. This remains an important segment of its market even today. Butyl rubber was first developed in 1937, at Standard Oil's (which became Exxon in 1972). in the 1950s and 1960s, halogenated butyl rubber (halobutyl) was developed, in its chlorinated (chlorobutyl) and brominated (bromobutyl) variant, providing significantly higher curing rates and allowing covulcanization with other rubbers like natural rubber and styrene-butadiene rubber. Halobutyl is today the most important material for inner tubes. The butyl rubber is vulcanized by elemental sulfur. Zinc oxide can be used to vulcanize halobutyl.

Styrene-Butadiene Rubber (SBR) is an elastomeric copolymer consisting of styrene and butadiene. It has good abrasion resistance and good aging stability. SBR is stable in mineral oils, fats, aliphatic, aromatic and chlorinated hydrocarbons. Possible temperature range: approx. −40 to +100 ***degrees sign***C. (−40 to +212 ***degrees sign***F.). Useful temperature range: −60 to 120 degrees Celsius (−75 to 250 degrees Fahrenheit). Major application characteristics: good physical propertied; excellent abrasion resistance; not oil, ozone, or weather resistant; electrical properties good, but not outstanding. Typical applications: pneumatic tires and tubes; heels and soles; gaskets.

Most of the early tires were white, the natural color of rubber. Some were tinted with a pigment and were light gray or tan or beige. Polyisobutylene based rubber for example is colorless to light yellow. But by World War I, they were all black. There were black because tire manufacturers began adding carbon black ask to the rubber recipe to enhance toughness and wear-ability to protect against ozone and UV damage.

### PARTS

1. Tile before treatment
2. Collected dust
3. Unsealed Grooves
4. Tile after treatment
5. Sealed Grooves
6. Sealing (rubber) material
7. Tire made of rubber or vulcanized rubber
8. Applied pressure or load
9. Pre-installed Tiles
10. Tiles not yet installed
11. Rotation direction
12. Motion direction

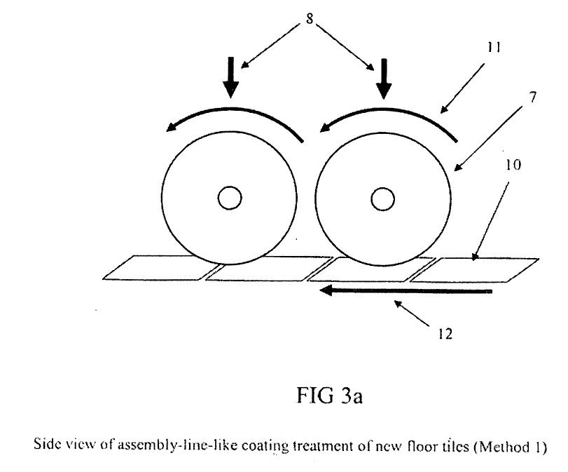

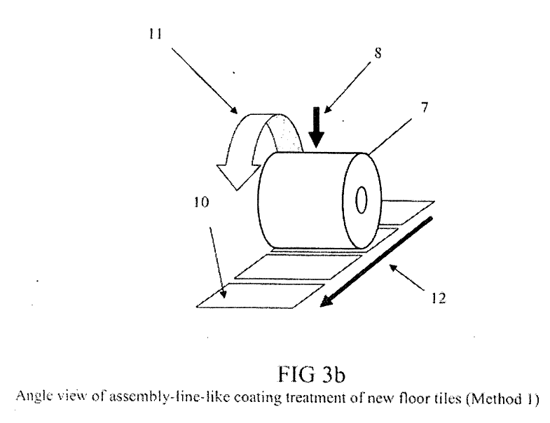

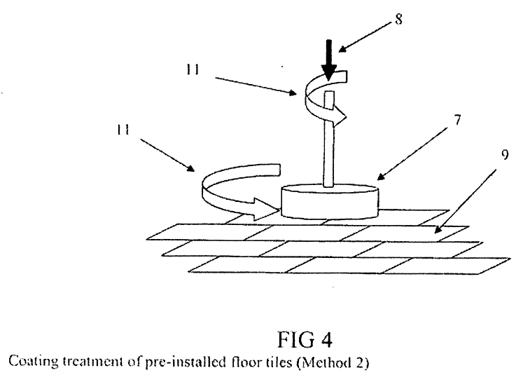

The rubber material is rubbed onto the tile mechanically as shown in FIGS. 3 and 4 to make a coating onto the tile. The coating provides sealing effect and the tiles exhibit dust-resisting properties (i.e. does not collect dust).

In the preferred embodiment the mechanism of dust proofing is achieved by two functions; (a) the thin rubber (polymer) coating plugs the pores on the rough tiles surface that usually collect dust easily, (b) the coating provides smooth surface so the dust is easily swept away by wind, (c) the coating provides electrical insulating effect, therefore, insulating/preventing the electrostatic forces that usually help the dust particles attach/stick themselves to the surface.

As shown in FIGS. 3a and 3b, new tiles are protected using an assembly-line-like coating treatment of the new floor tiles where a tire made of rubber or vulcanized rubber having an applied pressure or load applies the coating that plugs the pores on the rough tile surface and comes from the surface of the tire. If the preferred embodiment, the coating comes off from the tire as the tire is made of the coating material.

The rubber is applied by rubbing it onto the surface of the tile at normal to slightly higher temperature (−75 to 250 ***degrees sign***F.) with best result being at slightly higher temperature (120 ***degrees sign***F.).

The rubber is applied by rubbing it onto the surface of the tile at normal to higher pressure of (1 to 1000 kilogram weight per square inch) with 100 kilogram weight per square inch being more preferred.

When tiles are already installed, a rotating rubber disk may be pressed against the tiles and rubbed in circular motion as shown in FIG. 4 using mechanical means to apply the coating to the tiles.

When the tiles are in the manufacturing stage and not yet installed, a rotating rubber disk may be pressed against the tiles and rubbed in circular motion as shown in FIG. 3 using mechanical means.

Treatable floor tiles may be ceramic, marble, granite, or laminated cement (cashi) type tiles.

### ADVANTAGES

Japanese Patent no. 63-286471 (1988) to Takami et al. relates to the making of synthetic vinyl tiles that have dust resisting properties. The present invention provides dust proofing of ceramic, granite, marble, or laminated cement type synthetic tiles that have been installed or not yet installed. The disclosed method is simple and the disclosed compounds are widely available and cheap. Furthermore, the invention saves money and effort of continuously cleaning in dusty regions.

From the foregoing description, one skilled in the art can easily ascertain the essential characteristics of this invention and, without departing from the spirit and scope thereof, can make various changes and modifications of the invention to adapt it to various usages and conditions. Such variations and changes may include, for example, altering the number of components in the housing or using equivalents. It is believed that such can be accomplished without excessive experimentation. In any case, any such variations are all claimed under the scope of this invention.

The methods of the present invention have been explained with reference to plurality or references the teachings of which are all incorporated herein by reference.

This invention has been described hereinabove, although with reference to a plurality of illustrative exemplary and preferred embodiments, it is to be understood that is in no way to be construed as limiting but only to provide examples. However, it is readily appreciated that, from reading this disclosure, the invention may be embodied in other specific forms without departing from the spirit or essential characteristics or attributes to bring modifications by replacing some elements of this invention as practiced by their equivalents, which would achieve the same goal thereof and accordingly reference should be made to the appended claims, rather than to the foregoing specification, as indicating the scope of the invention. Accordingly, those skilled in the art will recognize, or be able to ascertain using no more than routine experimentation, many equivalents to the specific embodiments and the scope of the invention being indicated by the appended claims described herein. Such equivalents, obvious variations, and all changes which come within the meaning and equivalency of the claims are therefore intended to be encompassed therein and are deemed covered by the claims of this invention.

We claim:

1. A composition for making floor tiles resistant to dust accumulation wherein the compounds are applied in the form of a coating to said tiles by rubbing said chemical compounds against said floor tiles with applied pressure.

2. The composition of claim 1 wherein the tiles are made of one or more of a group comprising granite, ceramic, plastic, marble, or laminate cement.

3. The composition of claim 1 wherein the compound is comprised of a group comprising, natural rubber, polymerized natural latex, polymerized isoprene (2-methylbuta-1,3-diene), synthetic rubber, artificially made polymer or copolymer material which acts as an elastomer, a polymer obtained from the polymerization of a variety of monomers including isoprene (2-methyl-1,3-butadiene), 1,3-butadiene, chloroprene (2-chloro-1,3-butadiene), isobutylene (methylpropene) with a small percentage of isoprene, cis-1,4-polyisoprene, trans-1,4-polyisoprene, elastomer based on polychloroprene, Neoprene, Butyl rubber, polyisobutylene, polypropylene, halogenated butyl rubber (halobutyl), chlorinated butyl rubber (chlorobutyl), or brominated butyl rubber (bromobutyl), Styrene-Butadiene Rubber (SBR).

4. The composition of claim 3 wherein the compound is further vulcanized by elemental sulfur.

5. The composition of claim 3 wherein the compound is further vulcanized by zinc oxide.

6. The composition of claim 3 wherein the pressure is between the range of 1 to 1000 kilogram weight per square inch.

7. The composition of claim 3 wherein the temperature range being between −75 to 250 degrees F.

8. The composition of claim 1 wherein the compounds are manufactured into a tire.

9. A method for making floor tiles dustproof by coating it with chemical compounds.

10. The method of claim 9 wherein the tiles are made of one or more of a group comprising granite, ceramic, plastic, marble, or laminate cement.

11. The method of claim 9 wherein the compound is comprised of a group comprising, natural rubber, polymerized natural latex, polymerized isoprene (2-methylbuta-1,3-diene), synthetic rubber, artificially made polymer or copolymer material which acts as an elastomer, a polymer obtained from the polymerization of a variety of monomers including isoprene (2-methyl-1,3-butadiene), 1,3-butadiene, chloroprene (2-chloro-1,3-butadiene), isobutylene (methylpropene) with a small percentage of isoprene, cis-1,4-polyisoprene, trans-1,4-polyisoprene, elastomer based on polychloroprene, Neoprene, Butyl rubber, polyisobutylene, polypropylene, halogenated butyl rubber (halobutyl), chlorinated butyl rubber (chlorobutyl), or brominated butyl rubber (bromobutyl), Styrene-Butadiene Rubber (SBR).

12. The method of claim 9 wherein the compound is/manufactured into a shape that can be used to be rubbed against the floor tiles.

13. The method of claim 12 wherein the said shape is a disk.

14. The method of claim 12 wherein the said shape is a tire.
